(19) United States
(12) Patent Application Publication
(10) Pub. No.: US 2009/0153531 A1
(43) Pub. Date: Jun. 18, 2009

(54) DIGITAL INVERTER AND MONITOR CONTROL APPARATUS

(75) Inventors: Chung Wei TSENG, Taichung City (TW); Pin Jui JEN, GaoSyong City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: DARFON ELECTRONICS CORP., Taoyuan (TW)

(21) Appl. No.: 12/105,786

(22) Filed: Apr. 18, 2008

(30) Foreign Application Priority Data
Dec. 14, 2007 (TW) 096147820

(51) Int. Cl. G06F 3/038

(52) U.S. Cl. 345/204

(57) ABSTRACT

The present invention provides a digital inverter and monitor control apparatus for controlling optical characteristics of a monitor. The digital inverter of the invention comprises a formula or a lookup table storing a plurality of default control parameters and a plurality of default optical parameters which each corresponds to one of the control parameters. Furthermore, the digital inverter can search the lookup table to find one of the control parameters to be a current control parameter in accordance with an input signal and set the default optical parameter corresponding to the current control parameter as a current optical parameter. Additionally, the digital inverter can generate an optical regulating signal in accordance with the current optical parameter, so as to control the optical characteristics of the monitor.

### BACKGROUND OF THE INVENTION

1. Field of the Invention

The present invention relates generally to a digital inverter and a monitor control apparatus.

2. Description of the Prior Art

With the development of electronic products in recent years, multimedia systems for business or home use have been getting more and more popular. In most of the multimedia systems, the most important part is the display system. Therefore, how to arise the quality of the display system has been highly respected for the designers.

Please refer to FIG. 1, which illustrates a functional block of a display system of the prior art. The display system 7 includes an analog inverter 70, an analog control unit 71, a driver 72, a transformer 74, and a display unit 76. The analog control unit 71 can be an analog IC. The analog inverter 70 can supply a control signal to the driver 72, and the driver 72 can adjust a power source based on the control signal. Practically, the driver 72 can optionally be a full-bridge circuit, a half-bridge circuit, a push-pull circuit, or a royal circuit. Generally, the control signal is a PWM signal. The transformer 74 can receive the adjusted power source and can step up the power source to supply to the lighting unit 76A of the display unit 76. Practically, the lighting unit 76A can comprise a cold cathode fluorescent lamp (CCFL) or a light emitting diode (LED).

Furthermore, the features, such as the voltage level, the current level, the frequency, the duration time, and the amplitude, of the control signal provided by the analog control unit 71, can be changed in accordance with parameters to regulate the optical characteristics, such as the brightness or renew frequency, of the display unit. Moreover, the features of the control signal provided of the above-mentioned analog inverter 70 can be adjusted in accordance with the operation voltage or current feedback from the display unit 76 and the lighting unit 76A, so as to regulate the optical characteristics of the display unit 76.

However, because the inverter of the prior art applies analog control units to operate, a large amount of passive devices such as electric resistances and electric capacities should be applied to adjust the control signal. Moreover, when the optical characteristics of the display unit 76 can not comply with specifications, the manufactures have to artificially tune the passive devices, so that the cost and time for producing the inverter or the display system are increased. Please refer to U.S. Pat. Nos. 6,396,722, 6,259,615, and 6,804,129 for related technologies of the analog inverter of the prior art.

### SUMMARY OF THE INVENTION

Accordingly, an aspect of the present invention is to provide a digital inverter to control optical characteristics of a monitor. Particularly, the digital inverter of the invention can reach the same performance of the traditional inverter without using too many passive devices, so as to lower the complexity and cost of the design.

According to an embodiment of the invention, the digital inverter includes a lookup table which stores a plurality of default control parameters and a plurality of default optical parameters which each corresponds to one of the default control parameters. Additionally, the digital inverter can search the lookup table to find one of the default control parameters to be a current control parameter in accordance with an input signal, set the default optical parameter corresponding to the current control parameter as a current optical parameter, generate an optical regulating signal in accordance with the current optical parameter, and control the optical characteristics of the monitor based on the optical regulating signal.

According to another embodiment of the invention, the digital inverter includes a digital control unit which has a formula. Particularly, the input of the formula is a control parameter and the output of the formula is a current optical parameter. The digital control unit generates an optical regulating signal in accordance with the current optical parameter and controls the optical characteristics of the monitor based on the optical regulating signal.

Another aspect of the present invention is to provide a monitor control apparatus to control optical characteristics of a monitor.

According to an embodiment of the invention, the monitor control apparatus includes a digital inverter which includes a lookup table for storing a plurality of default control parameters and a plurality of default optical parameters which each corresponds to one of the default control parameters. Particularly, the digital inverter can search the lookup table to find one of the default control parameters to be a current control parameter in accordance with an input signal, set the default optical parameter corresponding to the current control parameter as a current optical parameter, generate an optical regulating signal in accordance with the current optical parameter, and control the optical characteristics of the monitor based on the optical regulating signal.

According to another embodiment of the invention, the monitor control apparatus includes a digital inverter which includes a digital control unit, and the digital control unit includes a formula. Particularly, the digital control unit generates a control parameter in accordance with an input signal; the formula generates a current optical parameter according to the control parameter; and the digital control unit generates an optical regulating signal in accordance with the current optical parameter and controls the optical characteristics of the monitor based on the optical regulating signal.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a functional block of a display system of the prior art.

FIG. 2 illustrates a functional block of a digital inverter of an embodiment of the invention.

FIG. 3A illustrates a lookup table of an embodiment of the invention.

FIG. 3B illustrates a lookup table of an embodiment of the invention.

FIG. 4 illustrates a functional block of a monitor control apparatus of an embodiment of the invention.

FIG. 5A shows a flow chart of a monitor control method of an embodiment of the invention.

FIG. 5B shows a flow chart of a monitor control method of an embodiment of the invention.

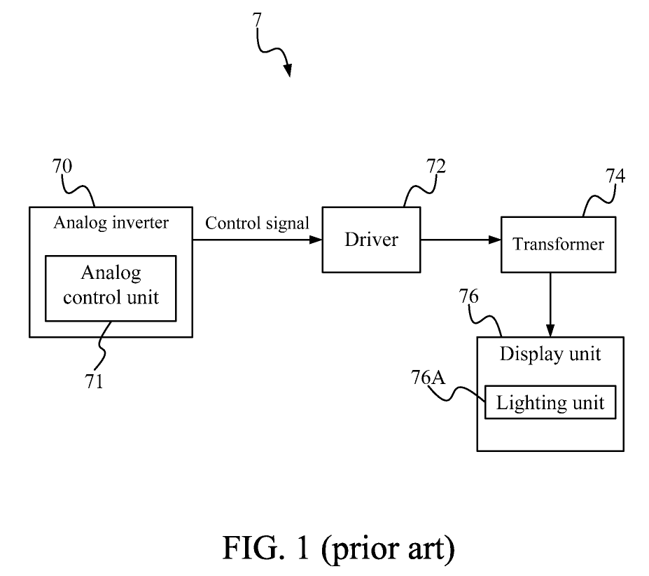

### DETAILED DESCRIPTION OF THE INVENTION

The present invention provides a digital inverter and monitor control apparatus for controlling optical characteristics of a monitor. In practice, the monitoring can be a liquid crystal display (LCD) which comprises a backlight module. Additionally, the backlight module can include lighting units such as cold cathode fluorescent lamp (CCFL) or light-emitting diode (LED). Practically, the controlled optical characteristics can be, but not limited to, the brightness of the lighting units, the current of the lighting units, the voltage of the lighting units, and the voltage of a protecting circuit.

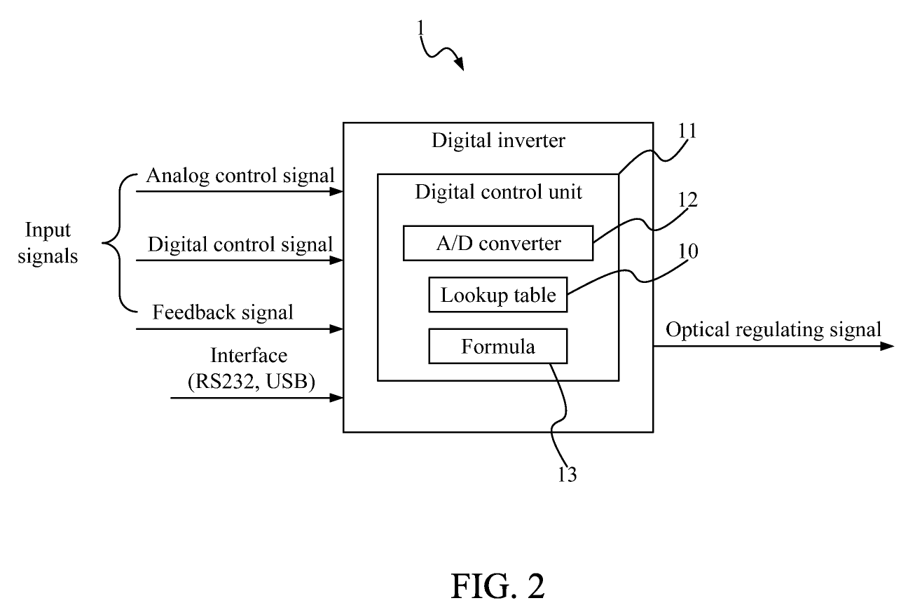

Please refer to FIG. 2, which illustrates a functional block of a digital inverter of an embodiment of the invention. As shown in FIG. 2, the digital inverter 1 includes a lookup table 13, a formula 13, and an analog/digital converter 12. The lookup table 10 can store a plurality of default control parameters and a plurality of default optical parameters which each corresponds to one of the control parameters. The formula 13 can optionally be linear relationship such as y=ax, non-linear relationship, differential relationship, or integral relationship. The A/D converter 12 can receive analog control signal (such as analog optical regulating signal), and can convert the analog control signal to the input signal. As shown in FIG. 2, the input signal can be, but not limited to, analog control signal, digital control signal, or feedback signal. Moreover, the optical regulating signal is generally a PWM signal.

Additionally, the digital inverter 1 can search the lookup table 10 to find one of the default control parameters to be a current control parameter in accordance with an input signal (e.g. the digital control signal as described above), and can set the default optical parameter corresponding to the current control parameter as a current optical parameter. Afterward, the digital inverter 1 can generate an optical regulating signal in accordance with the current optical parameter and control the optical characteristics of the monitor based on the optical regulating signal. Please note that the digital inverter 1 of the invention can directly receive digital control signals, or can receive analog control signals as the input signal through the A/D converter 12. Moreover, the digital inverter 1 can adjust the optical regulating signal based on the formula 13. The input of the formula 13 is the input signal, and the output of the formula 13 is the optical regulating signal.

In practice, the default optical parameter can be, but not limited to, a duty cycle parameter, a brightness parameter, a frequency parameter, an amplitude parameter, a time parameter, or other suitable parameter. For example, the duty cycle parameter can include a high frequency parameter and/or a low frequency parameter; the frequency parameter can include a high frequency duty cycle parameter and/or a low frequency duty cycle parameter; and the time parameter can comprise the duration time of certain duty cycle or the time needed to reach certain brightness.

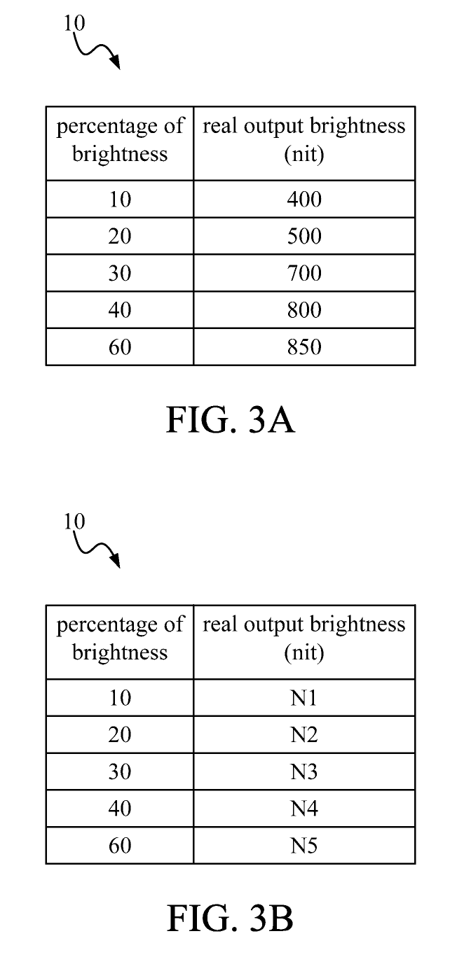

Please further refer to FIG. 3A which illustrates a lookup table of an embodiment of the invention. As shown in FIG. 3A, the default control parameters stored in the lookup table 10 are the percentage of brightness, whereas the default optical parameters are the real output brightness (nit). For example, when the digital inverter 1 receives the input signal which includes the percentage of brightness equals to 20%, the digital inverter 1 can search the lookup table 10 in FIG. 3A to find out the corresponding optical parameter—the real output brightness is equals to 500 nit. At that time, the digital inverter 1 can generate the optical regulating signal representing the optical parameter.

Please further refer to FIG. 3B which illustrates a lookup table of an embodiment of the invention. As shown in FIG. 3B, the default control parameters stored in the lookup table 10 are the percentage of brightness, whereas the default optical parameters are the low frequency duty cycle parameters. Please note that the contents of the lookup table 10 of the digital inverter 1 can be obtained by suitable calculating processes or experience, so that the value of parameters between columns is not absolute related (e.g. equal difference, geometric progression). On the other hand, the designers can fill any needed parameter in the lookup table 10; therefore, the low frequency duty cycle parameter can be any suitable value.

As shown in FIG. 2, in practice, the digital inverter of the invention can be connected to a computer through RS232, USB, or other suitable interface. Furthermore, designers can input any desire control parameter to the digital control unit 11 through a computer.

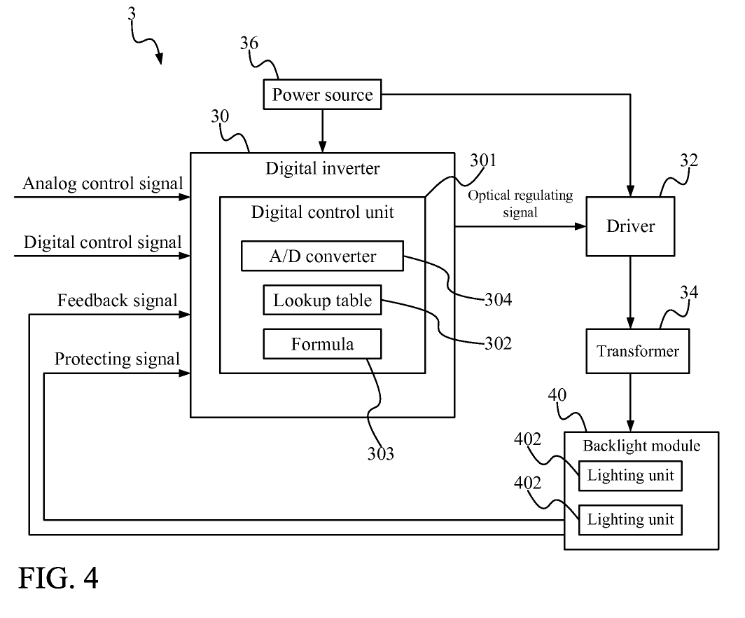

Please refer to FIG. 4 which shows a functional block of a monitor control apparatus of an embodiment of the invention. As shown in FIG. 4, the monitor control apparatus 3 includes a digital inverter 30, a driver 32, and a transformer 34. The digital inverter 30 can include the above-mentioned digital control unit 301, lookup table 302, formula 303, and A/D converter 304 to perform the above-mentioned functions. The function and content of the lookup table 302 and the formula 303 are the same as mentioned before, and discussion of unnecessary details will be hereby skipped.

Additionally, the input signal can include analog control signal, digital control signal, feedback signal, or protecting signal. The input of the formula 303 is an input signal, and the output of the formula 303 is an optical regulating signal. Moreover, we can choose the lookup table or the formula or both to adjust the optical regulating signal. The feedback signal can be the current value or voltage value of the lamp. Furthermore, when a short or open happened inside the backlight module 40, the digital control unit 301 will receive a protecting signal larger or smaller than a threshold value Vt stored in the lookup table, so that the digital control unit stops to output the optical regulating signal.

Because of the difference of material and production process, the value of protecting signal (about voltage or current) of each digital inverter will be slightly different. Traditionally, the level of voltage or current of the protecting signal is changed by artificially soldering electric resistances or capacities. On the contrary, the value of Vt can be changed by a user via an interface (e.g. USB or RS232) to amend the error caused by different production process.

Furthermore, the driver 32 is connected to the digital inverter 30 and the power source 36 for receiving the optical regulating signal from the digital inverter 30 and regulating the power source 36 to be a control power source in accordance with the optical regulating signal. In practice, the driver 32 can adjust the features, such as voltage, current, frequent, or other suitable features, of the power source 36.

The transformer 34 is connected to the driver 32 and the backlight module 40, wherein the backlight module includes at least a lighting unit 402. The transformer 34 can receive the control power source from the driver 32, and can step up the control power source to drive the lighting unit 402 to light.

In the embodiment, the digital inverter 30 can adjust the optical regulating signal in accordance with the feedback signals from the transformer 34 or the backlight module 40. Practically, the feedback signals can include, but not limited to, the brightness, the current, or the voltage of the lighting unit.

Please note that, in practice, the monitor control apparatus can be integrated in the backlight module or with other devices of the monitor, or can exist independently in the monitor.

Furthermore, the digital inverter or monitor control apparatus can be integrated in the backlight module of the monitor before leaving the factory, and the content of lookup table of the digital inverter can be adjusted in accordance with the feedback signals to reach the optimal result.

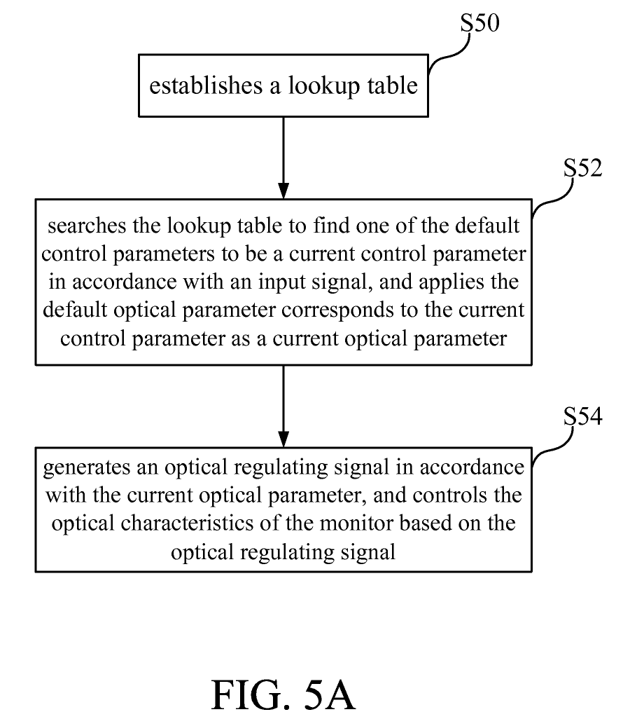

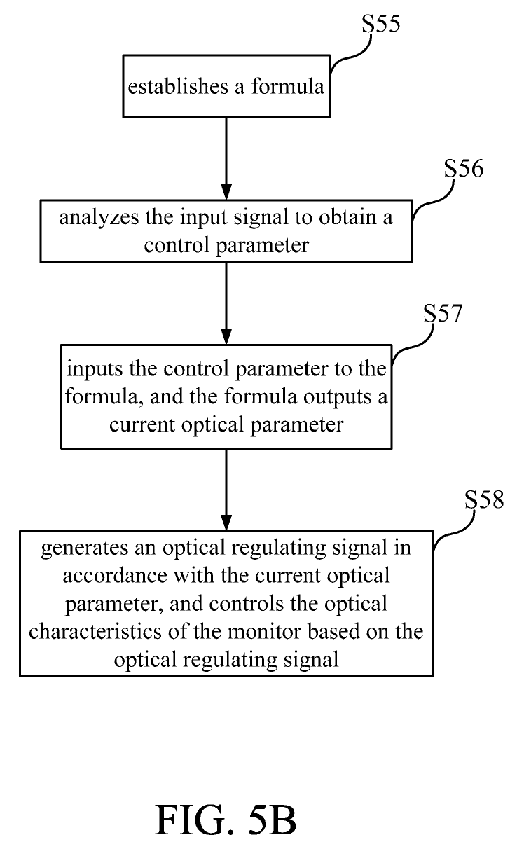

Please refer to FIG. 5A, which shows a flow chart of a monitor control method of an embodiment of the invention. As shown in FIG. 5A, the monitor control method of the invention comprises the following steps:

First of all, in step S50, establish a lookup table for storing the above-mentioned default control parameter (such as the percentage of brightness in FIG. 3A) and a plurality of default optical parameters (such as the real output brightness in FIG. 3A) which each corresponds to one of the control parameters. Afterward, in step S52, search the lookup table to find one of the default control parameters to be a current control parameter in accordance with an input signal, such as an analog control signal, a digital control signal, a feedback signal, or a protecting signal, and set the default optical parameter corresponding to the current control parameter as a current optical parameter. Finally, in step S54, generate an optical regulating signal in accordance with the current optical parameter and control the optical characteristics of the monitor based on the optical regulating signal. Please note that the content of the lookup table in step S50 is the same as mentioned above, and discussion of unnecessary details will be hereby skipped. Furthermore, the analog control signal can be converted to be digital control signal through an A/D converter.

Please further refer to FIG. 5B which shows a flow chart of a monitor control method of another embodiment of the invention. As shown in FIG. 5B, the monitor control method can further comprise the following steps of: step S55—establishing a formula in the digital control unit; step S56—analyzing the input signal to obtain a control parameter by means of the digital control unit; step S57—inputting the control parameter to the formula and then the formula outputs a current optical parameter; and step S58—generating an optical regulating signal in accordance with the current optical parameter and controlling the optical characteristics of the monitor based on the optical regulating signal. In practice, the formula can be any suitable formula. For example, we can apply a linear formula, such as y=ax, to make the output and the input of the formula have a linear relationship, wherein “x” refers to the control parameter and “y” refers to the current optical parameter of the invention.

Please refer to U.S. Pat. Nos. 6,771,029 and 7,126,288 for related technologies of the digital inverter of the prior art.

To sum up, the digital inverter of the invention has higher flexibility in design. The content of the lookup table or the formula can be adjusted based on different requirements, and can be changed through a computer connected to the digital inverter. Furthermore, the digital inverter, monitor control apparatus and method of the invention can be used to largely reduce the amount of passive devices and effectively lower the complexity of design and the cost of production.

Although the present invention has been illustrated and described with reference to the preferred embodiment thereof, it should be understood that it is in no way limited to the details of such embodiment but is capable of numerous modifications within the scope of the appended claims.

1. A digital inverter for controlling optical characteristics of a monitor, the digital inverter comprising:
a digital control unit having a lookup table for storing a plurality of optical parameters, the digital control unit being capable of searching the lookup table to find a current optical parameter of the optical parameters in accordance with an input signal, and generating an optical regulating signal in accordance with the current optical parameter; and
a driver connecting to the digital control unit and the monitor, the driver being used for controlling optical characteristics of the monitor in accordance with the optical regulating signal.

2. The digital inverter of claim 1, further comprising:
an analog/digital converter for receiving an analog control signal and converting the analog control signal to the input signal.

3. The digital inverter of claim 1, wherein the optical parameters comprises at least one selected from the group consisting of a duty cycle parameter, a brightness parameter, a frequency parameter, an amplitude parameter, and a time parameter.

4. The digital inverter of claim 3, wherein the frequency parameter comprises a high frequency parameter and/or a low frequency parameter.

5. The digital inverter of claim 3, wherein the duty cycle parameter comprises a high frequency duty cycle parameter and/or a low frequency duty cycle parameter.

6. The digital inverter of claim 1, wherein the digital inverter is capable of generating the input signal in accordance with a feedback signal.

7. The digital inverter of claim 6, wherein the feedback signal is generated by a transformer or a backlight module.

8. The digital inverter of claim 6, wherein the feedback signal comprises at least one selected from the group consisting of the brightness of a lighting unit, the current of a lighting unit, and the voltage of a protecting circuit.

9. A monitor, comprising:
a digital inverter comprising a digital control unit having a lookup table for storing a plurality of optical parameters, the digital control unit being capable of searching the lookup table to find a current optical parameter of the optical parameters in accordance with an input signal, and generating an optical regulating signal in accordance with the current optical parameter;
a lighting unit; and
a driver connecting to the digital control unit and the lighting unit, the driver being used for controlling optical characteristics of the lighting unit in accordance with the optical regulating signal.

10. The monitor of claim 9, wherein the digital inverter further comprises:
an analog/digital converter for receiving an analog control signal and converting the analog control signal to the input signal.

11. The monitor claim 9, wherein the driver further connects to a power source, the driver regulates the power source to be a control power source in accordance with the optical regulating signal.

12. The monitor of claim 9, further comprising:
a transformer connecting to the driver and the lighting unit, for stepping up the output of the driver.

13. The monitor of claim 9, wherein the optical parameters comprises at least one selected from the group consisting of a duty cycle parameter, a brightness parameter, a frequency parameter, an amplitude parameter, and a time parameter.

14. The monitor of claim 13, wherein the frequency parameter comprises a high frequency parameter and/or a low frequency parameter.

15. The monitor of claim 13, wherein the duty cycle parameter comprises a high frequency duty cycle parameter and/or a low frequency duty cycle parameter.

16. The monitor of claim 9, wherein the digital inverter is capable of generating the input signal in accordance with a feedback signal.

17. The monitor of claim 16, wherein the feedback signal comprises at least one selected from the group consisting of the brightness of a lighting unit, the current of a lighting unit, and the voltage of a lighting unit.

18. A monitor control method for controlling optical characteristics of a monitor, comprising the following steps of:
establishing a lookup table for storing a plurality of optical parameters;
searching the lookup table to find a current optical parameter of the optical parameters in accordance with an input signal;
generating an optical regulating signal in accordance with the current optical parameter; and
controlling the optical characteristics of the monitor based on the optical regulating signal.

19. The monitor control method of claim 18, wherein the optical parameters comprise at least one selected from the group consisting of a duty cycle parameter, a brightness parameter, a frequency parameter, an amplitude parameter, and a time parameter.

20. The monitor control method of claim 19, wherein the frequency parameter comprises a high frequency parameter and/or a low frequency parameter.

21. The monitor control method of claim 19, wherein the duty cycle parameter comprises a high frequency duty cycle parameter and/or a low frequency duty cycle parameter.

22. A digital inverter for controlling optical characteristics of a monitor, the digital inverter comprising:
a digital control unit having a formula, the digital control unit being capable of generating a control parameter in accordance with an input signal, the formula being used for generating a current optical parameter in accordance with an control parameter, the digital control unit being capable of generating an optical regulating signal in accordance with the current optical parameter; and
a driver connecting to the digital control unit and the monitor, the driver being used for controlling the optical characteristics of the lighting unit in accordance with the optical regulating signal.

23. The digital inverter of claim 22, further comprising:
an analog/digital converter for receiving an analog control signal and converting the analog control signal to the input signal.

24. A monitor, comprising:
a digital inverter having a digital control unit having a formula, the digital control unit being capable of generating a control parameter in accordance with an input signal, the formula being used for generating a current optical parameter in accordance with an control parameter, the digital control unit being capable of generating an optical regulating signal in accordance with the current optical parameter;
a lighting unit; and
a driver connecting to the digital control unit and the lighting unit, the driver being used for controlling the optical characteristics of the lighting unit in accordance with the optical regulating signal.

25. The monitor of claim 24, wherein the digital inverter further comprising:
an analog/digital converter for receiving an analog control signal and converting the analog control signal to the input signal.

26. The monitor of claim 24, wherein the driver further connects to a power source, the driver regulates the power source to be a control power source in accordance with the optical regulating signal.

27. The monitor of claim 24, further comprising:
a transformer connecting to the driver and the lighting unit, for stepping up the output of the driver.

28. The monitor of claim 24, wherein the current optical parameters comprises at least one selected from the group consisting of a duty cycle parameter, a brightness parameter, a frequency parameter, an amplitude parameter, and a time parameter.

29. The monitor of claim 28, wherein the frequency parameter comprises a high frequency parameter and/or a low frequency parameter.

30. The monitor of claim 28, wherein the duty cycle parameter comprises a high frequency duty cycle parameter and/or a low frequency duty cycle parameter.

31. A monitor control method for controlling optical characteristics of a monitor, the monitor-controlling method comprising the following steps of:
establishing a formula;
generates a control parameter in accordance with an input signal;
applying the formula to generate a current optical parameter in accordance with the control parameter;
generating an optical regulating signal in accordance with the current optical parameter; and
controlling the optical characteristics of the monitor based on the optical regulating signal.

32. The monitor control method of claim 31, wherein the current optical parameter comprises at least one selected from the group consisting of a duty cycle parameter, a brightness parameter, a frequency parameter, an amplitude parameter, and a time parameter.

33. The monitor control method of claim 32, wherein the frequency parameter comprises a high frequency parameter and/or a low frequency parameter.

34. The monitor control method of claim 32, wherein the duty cycle parameter comprises a high frequency duty cycle parameter and/or a low frequency duty cycle parameter.

35. The digital inverter of claim 1, wherein lookup table stores a plurality of default control parameters respectively corresponding to the optical parameters, the digital inverter is capable of searching the lookup table to find one of the default control parameters to be a current control parameter in accordance with an input signal and setting the optical parameter corresponding to the current control parameter as the current optical parameter.

36. The monitor of claim 9, wherein the lookup table stores a plurality of default control parameters respectively corresponding to the optical parameters, the digital inverter is capable of searching the lookup table to find one of the default control parameters to be a current control parameter in accordance with an input signal and setting the optical parameter corresponding to the current control parameter as the current optical parameter.

37. The monitor control method of claim 18, further comprising the following steps of:
storing a plurality of default control parameters corresponding to the optical parameters;
searching the lookup table to find one of the default control parameters to be a current control parameter in accordance with an input signal; and
setting the optical parameter corresponding to the current control parameter as the current optical parameter.
